(19) United States
(12) Patent Application Publication
(10) Pub. No.: US 2020/0331163 A1
(43) Pub. Date: Oct. 22, 2020

(54) AQUEOUS DISPERSION OF VINYLIDENE CHLORIDE-ACRYLIC ACID-VINYL CHLORIDE TERPOLYMER FOR PREPARATION OF BARRIER COATING ON WOOD SUBSTRATES

(71) Applicant: Guangdong Huaran Paints. Co., Ltd, Guangdong Province (CN)

(72) Inventors: Gang Duan, Hinckley, OH (US); Shigang Fan, Foshan City (CN)

(21) Appl. No.: 16/959,089

(22) PCT Filed: Jan. 4, 2019
(86) PCT No.: PCT/US2019/012242

§ 371 Date: Jun. 29, 2020

(30) Foreign Application Priority Data
Jan. 5, 2018 (CN) 201810011700.9

(51) Int. Cl. B27K 3/50; C09D 5/00; C09D 127/08; C09D 15/00

(52) U.S. Cl. CPC B27K 3/50; C09D 15/00; C09D 127/08; C09D 5/002

(57) ABSTRACT

The present invention relates to use of an aqueous dispersion of vinylidene chloride-acrylic acid-vinyl chloride terpolymer as a barrier coating in wood substrates. In particular, the present invention relates to an article comprising (a) a wood substrate comprising at least one of tannin and rosin; (b) a primer coat directly applied on a major surface of the wood substrate, formed from a water borne clear paint comprising an aqueous dispersion of vinylidene chloride-acrylic acid-vinyl chloride terpolymer; and (c) one or more light-colored topcoat applied on the primer coating.

This application claims benefit of Chinese Application No. 2018100117009, filed on Jan. 5, 2018, the entirety of which is hereby incorporated by reference.

### TECHNICAL FIELD

The present invention relates to use of an aqueous dispersion of vinylidene chloride-acrylic acid-vinyl chloride terpolymer for preventing tannin and/or rosin from immigrating out from a wood substrate and an article comprising a barrier coating.

### BACKGROUND

With the continuous development of technological innovation, the comprehensive performance of waterborne coatings for wood products is continuously improving. As a result, the market share of waterborne wood coatings has increased over the past few years. Wood products including wooden furniture are the most commonly used products in production and life, and are mainly made of wood substrates which usually contain colored materials such as tannins, rosins and pigments. In the case where a color coating, in particular a light-colored coating, is required, these colored materials contained in the wooden substrate is apt to bleed out, resulting in a color change of the colored coating, particularly the light-colored coating thereon and affecting the appearance. Above issue occurs significantly under heating conditions.

In order to solve this problem, a cationic emulsion is usually used as a primer, and an ionic compound which can react with tannin is additionally added to the pain to reduce and/or eliminate tannin bleeding out. For example, CN 103642342 A discloses a water-repellent wood-sealing primer which comprises a cationic emulsion and a metal compound having an excellent association as an anti-penetration agent to prevent tannin bleeding out. CN 102417774 A discloses an aqueous white primer with modified barium borate. This white primer has a good sealing effect on substrates containing tannins, nicotine pigments and water-soluble pigments.

However, these prior arts have certain limitations. Due to the complexity of the tannin component and the variety of wood substrate types, the effect of adding anti-tannin agents alone is limited. The sealing effect of the cationic emulsion alone is also unsatisfactory. The sealing effect obtained by adding an anti-tannin agent to the cationic emulsion is acceptable in the short term, but over time, there is still a problem of tannin and/or gum such as rosin bleeding out. Moreover, the cationic emulsion acts as a seal primer that has a poor adhesion to the anionic coating thereon, and interlayer separation is easy to occur.

Thus, there is still a need to reduce or eliminate tannin and or rosin bleeding out.

### SUMMARY

In one aspect, the present invention discloses an article, comprising (a) a wood substrate, comprising at least one of tannin and rosin; (b) a primer coat directly applied on a major surface of the wood substrate, formed from a water borne clear paint comprising an aqueous dispersion of vinylidene chloride-acrylic acid-vinyl chloride terpolymer; and (c) at least one light-colored topcoat applied on the primer coating. Preferably, the topcoat has a color difference Δ E of no greater than 3 as measured with ASTM D2244 before and after being heated at 50° C. for 3 days.

In an embodiment of the present invention, the primer coat has a thickness in the range of 10-40 microns.

In an embodiment of the present invention, the aqueous dispersion is neutralized with a base.

In another aspect, the present invention discloses a method for preventing tannin and/or rosin from immigrating out from a wood substrate, comprising the step of directly applying an aqueous dispersion of vinylidene chloride-acrylic acid-vinyl chloride terpolymer on at least one major surface of the wood substrate.

In another aspect, the present invention discloses use of an aqueous dispersion of vinylidene chloride-acrylic acid-vinyl chloride terpolymer for preventing tannin and/or rosin from immigrating out from a wood substrate.

In the present invention, applicants have creatively provided a novel idea for solving the issue of tannin and/or rosin bleeding out by applying an aqueous dispersion of vinylidene chloride-acrylic acid-vinyl chloride terpolymer to the surface of a wood substrate as a primer coat. The formation of this primer coat significantly reduces or eliminates tannin and/or rosin bleeding out from the wood substrate so that a light-colored topcoat can be applied to the wood substrate with substantially no color change or little color change, even at high temperatures for long periods of storage.

The details of one or more embodiments of the invention will be set forth in description below. The other features, objectives, and advantages of the invention will become apparent.

### Definition

As used herein, “a”, “an”, “the”, “at least one”, and “one or more” are used interchangeably, unless indicated otherwise. Thus, for example, a coating composition that comprises “an” additive can be interpreted to mean that the coating composition includes “one or more” additives.

Throughout the present invention, where compositions are described as having, including, or comprising specific components or fractions, or where processes are described as having, including, or comprising specific process steps, it is contemplated that the compositions or processes as disclosed herein may further comprise other components or fractions or steps, whether or not specifically mentioned in this disclosure, as long as such components or steps do not affect the basic and novel characteristics of the invention, but it is also contemplated that the compositions or processes may consist essentially of or consist of the recited components or steps.

For the sake of brevity, only certain ranges are explicitly disclosed herein. However, ranges from any lower limit may be combined with any upper limit to recite a range not explicitly recited, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

When used in the context of wood substrates, the term “major surface” is a surface defined by the lengthwise and widthwise dimensions of the wood substrates for providing the decoration.

When used in the context of a topcoat, the term “light-colored” refers to a color that is more reflective to light, usually including white, tin white, goose yellow, pale pink, fruit green, pinkish green, light blue, lavender, but not limited to this.

When used in the context of a topcoat, the term “color difference” is a parameter used to measure the color change of the top coat. The smaller the color difference, the smaller the color change of the top coat is.

The term “on” when used in the context of one or more light-colored topcoat applied on a primer coat” includes the topcoat being applied directly or indirectly on the primer coat. In some embodiments of the present invention, the topcoat is applied directly to the primer coat and is in direct contact with the primer cost. In some embodiments of the present invention, one or more functional layers may be present between the topcoat and the primer coat so as to achieve the desired performance.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

### DRAWINGS

FIG. 1 shows a photograph of a plywood coated with a coating in which STD represents that a white topcoat is applied to a plywood impregnated with tannin or rosin; Examples 14 represent that an aqueous dispersion containing a vinylidene chloride/acrylic acid/vinyl chloride terpolymer as a primer coat and a white topcoat are applied to a plywood coated with 10% aqueous tannin solution, 20% aqueous tannin solution, 10% rosin solution in tetramethylbenzene, 20% rosin solution in tetramethylbenzene, respectively; and Comparative Examples 14 represent that a white topcoat is applied to a plywood coated with 10% aqueous tannin solution, 20% aqueous tannin solution, 10% rosin solution in tetramethylbenzene, 20% rosin solution in tetramethylbenzene, respectively.

FIGS. 2-5 show cross-sectional views of the plywood coated with a coating corresponding to the above STD, Examples 14, and Comparative Examples 14.

### DETAILED DESCRIPTION

In one aspect, the present invention discloses an article, comprising (a) a wood substrate, comprising at least one of tannin and rosin; (b) a primer coat directly applied on a major surface of the wood substrate, formed from a water borne clear paint comprising an aqueous dispersion of vinylidene chloride-acrylic acid-vinyl chloride terpolymer; and (c) at least one light-colored topcoat applied on the primer coating. Preferably, the topcoat has a color difference Δ E of no greater than 3 as measured with ASTM D2244, preferably of no greater than 2.5 as measured with ASTM D2244 before and after being heated at 50° C. for 3 days.

### Wood Substrate

As the wood substrate used to make the article of the present invention, any suitable wood substrate known in the art can be used. According to the present disclosure, the term “wood substrate” refers to any material of cellulose/lignin derived from the hard, fibrous structural tissue in the stems and roots of trees or other woody plants. Wood includes, for example, hardwood and softwood lumber directly cut from trees, as well as engineered wood composites made from strands, particles, fibers or veneers of wood. Examples of wood composites include, but are not limited to, plywood, oriented strand board (OSB), medium-density fiberboard (MDF), particle boards, and the like. Exemplary woods include hardwood species such as ashtree, white ash, basswood, elm, birch, alder, beech, oak, rubber wood, cherry, mahogany, maple, oak, poplar, teak, hickory walnut, or rosewood and softwood species such as cedar, fir, or pine. Finished wood products coated with such compositions can have a wide variety of end uses including furniture, kitchen cabinetry, flooring (including engineered flooring), and doors and trim. The wood can be cut or formed into a wide variety of shapes for use as a structural or a building material. In an embodiment of the present invention, a plywood is used as the wood substrate.

According to the invention, the wood substrate has at least one, preferably two, major surfaces that are opposite one another. As used herein, “major surface” is a surface defined by the lengthwise and widthwise dimensions of the wood substrate for providing the decoration. In view of the fact that the present invention is directed to solving the problem of tannin and/or rosin bleeding out from a wood substrate to reduce discoloration of the topcoat, the major surface of the wood substrate excludes the backsides of the wood, i.e., the non-decorative surface.

Preferably, the major surface of the wood substrate may contain polar groups such as hydroxyl groups, amino groups, mercapto groups, etc., so that the aqueous dispersion of vinylidene chloride-acrylic acid-vinyl chloride terpolymer according to the present invention can easily wet the major surface when it is applied thereto. Methods for obtaining a wood substrate having a major surface with hydroxyl groups are known in the art. Specifically, the hydroxyl group may be introduced on the surface of the wood substrate by performing surface treatment on the major surface of the wood substrate, for example, by corona treatment.

According to the present invention, the content of tannin or rosin in the wood substrate can vary over a wide range. In one embodiment of the invention, the wood substrate has a tannin or rosin content of at least 0.1 wt %. In another embodiment of the invention, the wood substrate has a tannin or rosin content of at least 1 wt %. In still another embodiment of the present invention, the wood substrate has a tannin or rosin content of at least 10 wt %.

The inventors of the present invention have surprisingly found that a primer coat formed from a water-based varnish comprising an aqueous dispersion of a vinylidene chloride/acrylic acid/vinyl chloride terpolymer can even prevent tannis and rosin from bleeding out from a wood substrate having an extremely high tannin or rosin content (e.g., up to 10 wt % or higher), and still maintains a good sealing effect even when it is stored for a long term at high temperatures.

### Primer Coat

In the article according to the present invention, a primer coat is applied directly onto the major surface of the wood substrate, which is formed from an aqueous dispersion of a vinylidene chloride/acrylic acid/vinyl chloride terpolymer.

According to the invention, the primer layer can be applied in any thickness, for example at a thickness of from 10 to 45 microns, preferably at a thickness of from 10 to 30 microns. The inventors of the present invention have surprisingly found that the primer coat formed from a water-based varnish comprising an aqueous dispersion of a vinylidene chloride/acrylic acid/vinyl chloride terpolymer can still prevent tannins and rosins immigration out from in wood substrates, even at a lower thickness (e.g., 10-25 microns, even 10-20 micron), which was previously unpredictable prior to the present invention.

According to the invention, the water-based varnish used to form the primer coat comprises an aqueous dispersion of a vinylidene chloride/acrylic acid/vinyl chloride terpolymer.

In the context of the present invention, an aqueous dispersion of a vinylidene chloride/acrylic acid/vinyl chloride terpolymer refers to an aqueous dispersion of an acrylic acid-modified vinyl chloride-vinylidene chloride copolymer, wherein the terpolymer comprises polyvinyl chloride as a hard segment and polyvinylidene chloride as a soft segment, and the terpolymer may be dispersed in an aqueous solvent including water, a water-miscible solvent or a combination thereof, preferably dispersed in water.

Preferably, the aqueous dispersion of the vinylidene chloride/acrylic acid/vinyl chloride terpolymer may be neutralized with a base. In accordance with the present invention, aqueous dispersions of vinylidene chloride/acrylic acid/vinyl chloride terpolymers can be neutralized using any suitable base, including, but not limited to alkali metal salts, alkaline earth metal salts, amines, aqueous ammonia, or combinations thereof. In one embodiment of the present invention, aqueous ammonia is used for neutralization. Taking into account the applicability on the wood substrate, the aqueous dispersion of the vinylidene chloride/acrylic acid/vinyl chloride terpolymer may optionally be neutralized to a suitable pH, preferably to a pH in the range of 3-6, more preferably to a pH in the range of 4-5.

The inventors of the present invention have surprisingly found that aqueous dispersions of alkali-neutralized vinylidene chloride/acrylic acid/vinyl chloride terpolymers are particularly suitable for formulating waterborne varnishes for coating wood substrates, and the resulting waterborne varnishes have good adhesion to the wood substrate and can achieve a balance between hardness and flexibility.

Preferably, the aqueous dispersion of the vinylidene chloride/acrylic acid/vinyl chloride terpolymer suitable for use in the present invention has a suitable viscosity. In one embodiment of the invention, the aqueous dispersion of the vinylidene chloride/acrylic acid/vinyl chloride terpolymer has a viscosity of 100 mPa·s or lower at 25° C., preferably has a viscosity of 75 mPa·s or lower at 25° C., and has a viscosity of 20 mPa·s or higher at 25° C., preferably has a viscosity of 30 mPa·s or higher at 25° C. The viscosity can be measured using a Brookfield viscometer at 25° C. It has been observed that an aqueous dispersion of a vinylidene chloride/acrylic acid/vinyl chloride terpolymer having a suitable viscosity can be more conveniently applied to a wood substrate to provide substantially complete protective layer on the surface of the wood substrate.

Aqueous dispersions of vinylidene chloride/acrylic acid/vinyl chloride terpolymers can be prepared by suitable methods well known to those skilled in the art, such as by emulsion polymerization. Alternatively, any suitable commercially available product, those available under the tradename DIOFAN (available from Solvay Plastics), SURFENE from Dow Chemical, Midland, Mich., POLIDENE (e.g., 33-082, 33-038, 33-086, 33-083, 33-075, and 33-081 available from ScottBader), HALOFLEX (e.g., 202 and 202S available from DSMNeoresins), PERMAX (e.g., 803 and 805 available from Lubrizol), and the like may be used.

In the waterborne varnish for forming a primer layer according to the present invention, the amount of the aqueous dispersion of the vinylidene chloride/acrylic acid/vinyl chloride terpolymer can be selected within a wide range. In general, if the amount of the aqueous dispersion is too low, it may be difficult to form a film, and it is more difficult to form a film sufficiently adhered to the wood substrate, or the barrier property of the film may be insufficient. The waterborne varnish preferably comprises from about 60% to 90% by weight, more preferably from about 70% to 90% by weight, most preferably from about 75% to 90% by weight, based on the total weight of the water-based varnish, of the aqueous dispersion of the vinylidene chloride/acrylic acid/vinyl chloride terpolymer.

According to the present invention, the waterborne varnish for forming the primer coat further contains an aqueous solvent including water, a water-soluble organic solvent or a combination thereof. Preferably, the waterborne varnish used to form the primer coat further comprises water.

In the waterborne varnish for forming the primer coat according to the present invention, the amount of the aqueous solvent can be selected within a wide range to meet the requirements of application. The waterborne varnish preferably comprises from about 5% to 20% by weight, more preferably from about 9% to 20% by weight of water based on the total weight of the waterborne varnish.

According to the invention, the waterborne varnish used to form the primer coat may optionally further comprise additional additives commonly used in aqueous varnishes which do not adversely affect the coating composition or the cured coating obtained therefrom. Suitable additives include, for example, those that may improve the processability or manufacturability of the composition, enhance composition aesthetics, or improve a particular functional property or characteristic of the coating composition or the cured composition resulting therefrom, such as adhesion to a substrate. Additives that may be included are, for example, carriers, cosolvent, anti-migration aids, anti-microbials, extenders, lubricants, wetting agents, biocides, plasticizers, antifoaming agents, surfactants, anti-sagging agent, anti-oxidants, anticorrosion agents, dispersants, adhesion promoters, UV stabilizers, a thickener, a defoamer, a pH adjuster, coalescents, or combinations thereof. Each optional additive can be included in a sufficient amount to serve its intended purpose, but preferably not in such an amount to adversely affect a coating composition or a cured coating resulting therefrom. In one embodiment of the invention, the additional additive comprises cosolvents, coalescents, wetting agents, antifoaming agents, surfactants, anti-sagging agents, thickening agents, or a combination thereof.

In an embodiment according to the invention, the waterborne varnish comprises, based on the total weight of the waterborne vanish, from 60% to 90% by weight of the aqueous dispersion of vinylidene chloride/acrylic acid/vinyl chloride terpolymer; from 5% to 20% by weight of water, and from 0 to 35% by weight of additional additives selected from the group consisting of cosolvents, coalescents, wetting agents, defoamers, surfactants, anti-sagging agents, thickeners or a combination thereof.

In a preferred embodiment according to the present invention, the waterborne varnish comprises, based on the total weight of the waterborne vanish, from 70% to 90% by weight of the aqueous dispersion of vinylidene chloride/acrylic acid/vinyl chloride terpolymer from 9% to 20% by weight of water, and from 0.1% to 10% by weight of additional additives selected from the group consisting of cosolvents, coalescents, wetting agents, defoamers, surfactants, anti-sagging agents, thickeners or a combination thereof.

According to the present invention, the waterborne varnish can be applied by conventional application processes known to those skilled in the art. The application processes may comprise dip coating, spin coating, spray coating, curtain coating, brush coating, roll coating, or other application processes known in the art. In an embodiment of the present invention, the coating is carried out by using spray coating process.

### Light-Colored Topcoat

In the article of the present invention, a light-colored topcoat layer may be applied to the surface of the primer coat. In the context of the present invention, “light-colored topcoat” refers to a finish coat having a protective and decorative effect on the substrate, which has a color that may be strongly reflective to light, usually including but not limited to white, tin white, goose yellow, light pink, fruit green, pink green, light blue, lavender. Preferably, the topcoat according to the invention is white. The topcoat can be applied directly to the primer coat and can be in direct contact with the primer coat. In some embodiments of the invention, one or more functional coatings may be present between the topcoat and the primer coat formed from the waterborne varnish to achieve the desired properties.

According to the present invention, the topcoat may be formed from an aqueous coating composition or may be formed from a solvent-based coating composition, preferably from an aqueous coating composition.

According to the present invention, the aqueous coating composition for forming the topcoat may be any aqueous coating composition known to those skilled in the art that is suitable for coating wood substrates. In one embodiment of the invention, the aqueous coating composition is a water-soluble composition, preferably comprising polyvinyl alcohol as the film-forming resin. In another embodiment of the present invention, the aqueous coating composition is a water-dispersible composition, preferably comprising a film-forming resin including, but not limited to, an aqueous dispersion of organic silicone, an aqueous dispersion of styrene-acrylate, an aqueous dispersion of acrylates, an aqueous dispersion of organic silicone-modified acrylate, an aqueous dispersion of vinyl acetate, an aqueous dispersion of vinyl acetate-acrylate, an aqueous dispersion of vinyl acetate-ethylene, an aqueous dispersion of vinyl acetate-acrylate-esters of versatic acid, an aqueous dispersion of polyurethane, an aqueous dispersion of acrylate-polyurethane or any combination thereof.

The aqueous coating composition of the present invention may further comprise one or more fillers. As used herein, the term, “filler”, is intended to refer to any coating volume extender, either organic or inorganic, in the form of e.g., particles. There is no particular limitation on the shape of particles, and the filler may have any suitable shape. The particle size of the filler may vary over a broad range, e.g., from about 10 nanometers to about 50 micrometers. In addition to functioning as a coating volume extender, some fillers may impart one or more desired properties to the composition and/or coating resulted from the composition. For example, some fillers may impart desired color to the composition and hence the coating resulted from the composition, and in this case such fillers may be also referred to as “pigment”. Some fillers may improve chemical and/or physical properties, in particular mechanical properties of the coating resulted from the composition, and in this case they may also be referred to as “enforcingfiller”.

The present aqueous coating composition may optionally comprise additional additives for an aqueous coating composition which do not adversely affect the coating composition or a resultant coating obtained therefrom. Suitable additives include, for example, those that may improve the processability or manufacturability of the composition, enhance composition aesthetics, or improve a particular functional property or characteristic of the coating composition or the cured composition resulting therefrom, such as adhesion to a substrate. Additives that may be included are, for example, carriers, emulsifiers, pigments, anti-migration aids, anti-microbials, extenders, lubricants, wetting agents, biocides, plasticizers, antifoaming agents, colorants, waxes, anti-oxidants, anticorrosion agents, flow control agents, thixotropic agents, dispersants, adhesion promoters, UV stabilizers, a thickener, a defoamer, a pH adjuster, a silane coupling agent, a high boiling film forming agent, or combinations thereof. Each optional additive can be included in a sufficient amount to serve its intended purpose, but preferably not in such an amount to adversely affect a coating composition or a cured coating resulting therefrom.

According to the present invention, the preparation of the aqueous coating composition can be accomplished using any suitable method known to one of ordinary skill in the art. For example, the aqueous coating composition can be made by adding all of the components to a container and then stirring the resulting mixture until homogeneous. Alternatively, the aqueous coating composition can be made by firstly mixing some of the components and then adding the rest of the other components to form a homogeneous mixture. Alternatively, any suitable commercially available aqueous coating composition may be used, such as an acrylic aqueous colored varnish from Sherwin-Williams (previous Valspar China), such as white topcoat varnish XT81146.

According to the present invention, the aqueous coating composition can be applied by conventional coating processes known to those skilled in the art. The coating processes comprise dip coating, spin coating, spray coating, curtain coating, brush coating, roll coating, and other application processes known in the art. According to the present invention, a wet-on-dry coating process may be applied. Typically, an aqueous liquid medium comprising water and any co-solvent is removed by natural or accelerated (heat) drying to form a coating.

According to the present invention, the article can be prepared, for example, by (1) providing a milled wooden substrate; (2) applying a waterborne varnish comprising an aqueous dispersion of vinylidene chloride-acrylic acid-vinyl chloride terpolymer of the present invention to the wood substrate using a spray coating process, thereby forming a primer coat; and (3) applying a light-colored topcoat to the primer coat using a wet-on-dry coating process.

The inventors of the present invention have surprisingly found that the topcoat has a color difference Δ E of no greater than 3 as measured with ASTM D2244 before and after being heated at 50° C. for 3 days, even for 5 days.

According to the present invention, the articles thus obtained may be used for applications including, but not limited to, household furniture such as tables, chairs, cabinets and the like; bedroom and bathroom furniture; office furniture; custom furniture such as school and children's furniture, hospital furniture, restaurant and hotel furniture, kitchen cabinets and furniture; interior design panels; indoor and outdoor windows and doors; indoor and outdoor window and door frames; outdoor and indoor wall panels and wood floors.

In another aspect, the present invention discloses a method for preventing tannin and/or rosin from immigrating out from a wood substrate, comprising the step of directly applying a waterborne varnish comprising an aqueous dispersion of vinylidene chloride-acrylic acid-vinyl chloride terpolymer to at least one major surface of the wood substrate. Preferably, the aqueous dispersion is neutralized with a base, preferably is neutralized to a pH in the range of 3-6.

In another aspect, the present invention discloses use of a waterborne varnish comprising an aqueous dispersion of vinylidene chloride-acrylic acid-vinyl chloride terpolymer for preventing tannin and/or rosin from immigrating out from a wood substrate. Preferably, the aqueous dispersion is neutralized with a base, preferably is neutralized to a pH in the range of 3-6.

According to the present invention, the content of tannin or rosin in the wood substrate can vary over a wide range. In one embodiment of the invention, the wood substrate has a tannin or rosin content of at least 0.1 wt %. In another embodiment of the invention, the wood substrate has a tannin or rosin content of at least 1 wt %. In still another embodiment of the present invention, the wood substrate has a tannin or rosin content of at least 10 wt %. In still another embodiment of the present invention, the wood substrate has a tannin or rosin content of at least 20 wt %.

Such an aqueous dispersion of vinylidene chloride-acrylic acid-vinyl chloride terpolymer may be used to formulate a waterborne varnish which is suitable to be applied on a variety of wood substrates to address the problem of tannin and/or rosin bleeding out from the wood substrates. The treated wood substrate may be used for applications including, but not limited to, household furniture such as tables, chairs, cabinets and the like; bedroom and bathroom furniture; office furniture; custom furniture such as school and children's furniture, hospital furniture, restaurant and hotel furniture, kitchen cabinets and furniture; interior design panels; indoor and outdoor windows and doors; indoor and outdoor window and door frames; outdoor and indoor wall panels and wood floors.

The following examples describe the present invention in more detail, which are for illustrative purposes only, since various modifications and changes will be apparent to those skilled in the art from the scope of the present invention. Unless otherwise indicated, all parts, percentages, and ratios reported in the following examples are on a weight basis and all reagents used in the examples are commercially available and may be used without further treatment.

### EXAMPLES

Preparation of Waterborne Varnish

First, a mixture of 10 wt % water, 2.5 wt % dipropylene glycol methyl ether (DPM), 1.0 wt % Texanol, 0.2 wt % Sulfynol 1045 E water-based wetting agent, 0.3 wt % BYK 024 water-based defoaming and 0.2 wt % of Bentone LT anti-sagging agent was dispersed at a high speed (at 3000 rpm) for 25 minutes to obtain a premix. Then, 25 wt % of aqueous ammonia was added to Haloflex 202, and the pH was adjusted to 4.0, followed by mixing it at 600-800 rpm for 25 minutes, thereby obtaining neutralized Haloflex 202. Next, the neutralized Haloflex 202 was mixed with the premix and stirred at 300 rpm and 25° C. for 25 minutes to obtain a water-based varnish for use.

### Examples 1-4

Four plywood panels were separately immersed in a 10% aqueous tannin solution, a 20% aqueous tannin solution, a 10% rosin solution in tetraethylbenzene, and a 20% rosin solution in tetramethylbenzene overnight and then dried in air for 3 days.

Then, the four kinds of substrates thus obtained were coated as follows. Each substrate was applied with a white topcoat XT81146, and then dried in air for 7 days to obtain each sample, which was referred to as Comparative Examples 1-4, respectively. Similarly, each of substrates was applied with a layer of the waterborne varnish obtained above and a layer of the above-mentioned white topcoat, and then dried in the air for 7 days to obtain each sample, which was referred to as Examples 1-4, respectively. For comparison, a layer of the above white topcoat was applied on plywood not impregnated with tannin and rosin as a control STD.

The color difference Δ E of each sample was tested using a color difference meter (CC-6801 color difference meter) from BYK, and the results are shown in Table 1 below.

TABLE 1

| | Ex. 1 | CEx. 1 | Ex. 2 | CEx. 2 | Ex. 3 | CEx. 3 | Ex. 4 | CEx. 4 |
|---|---|---|---|---|---|---|---|---|
| Panels | 10% tannin | 10% tannin | 20% tannin | 20% tannin | 10% rosin | 10% rosin | 20% rosin | 20% rosin |
| Δ E | 0.39 | 5.37 | 2.34 | 6.17 | 0.66 | 1.81 | 0.82 | 2.02 |

From the above results, it can be seen that the primer coat formed from the waterborne varnish comprising the aqueous dispersion of the vinylidene chloride/acrylic acid/vinyl chloride terpolymer has a remarkable barrier effect and can significantly reduce the color difference caused by bleeding out of tannin or rosin.

In order to more visually show the barrier effect of the primer coat formed from the waterborne varnish comprising the aqueous dispersion of vinylidene chloride/acrylic acid/vinyl chloride terpolymer on tannin or rosin bleeding out, the surface and cross section of each sample were imaged.

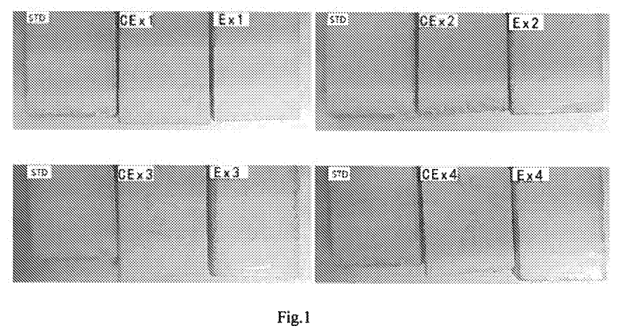

FIG. 1 shows a photograph of a coated plywood taken with a digital camera. As shown, the white topcoat undergoes little color change with the aid of the primer coat formed from an aqueous dispersion of a vinylidene chloride/acrylic acid/vinyl chloride terpolymer. In contrast, the plywood without the undercoat layer showed a significant color change, indicating that the primer coat formed from the aqueous dispersion of the vinylidene chloride/acrylic acid/vinyl chloride terpolymer has a significant barrier effect on the tannin or rosin bleeding out.

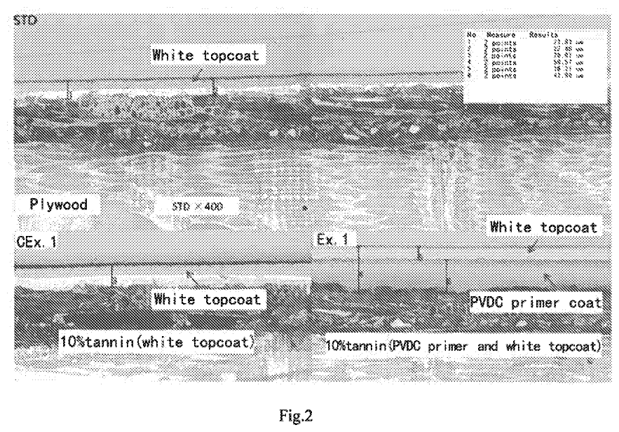

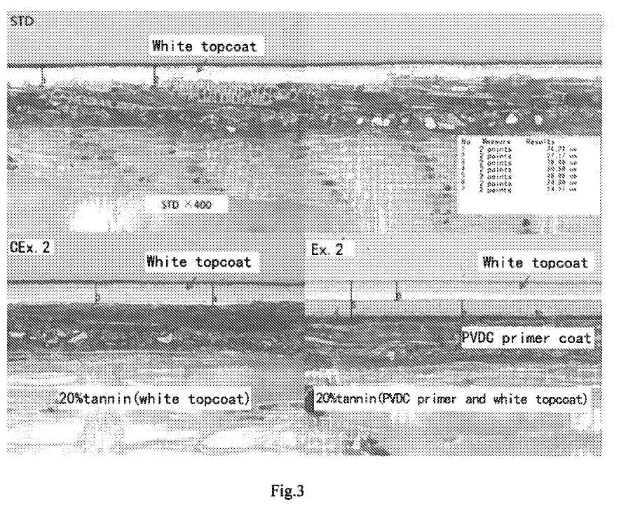

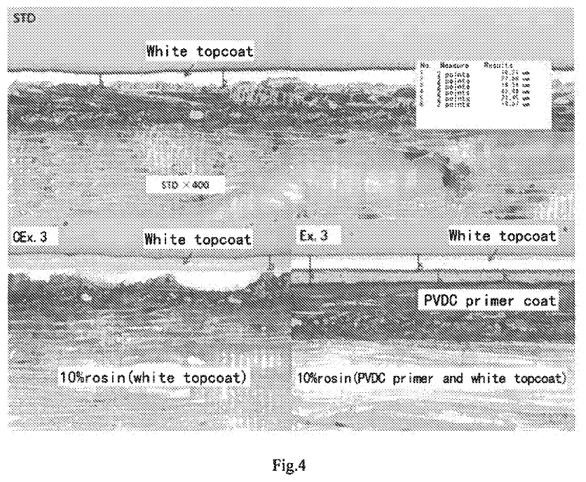

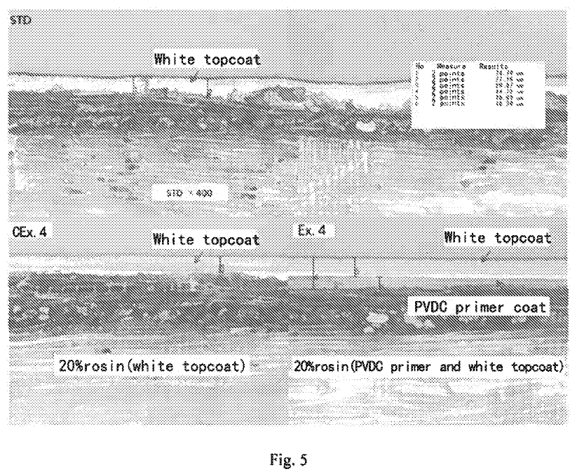

FIG. 2-5 shows a cross-sectional view of a coated plywood taken in a dark field mode using an optical microscope of Keyence VHX-5000 with a Z1000 lens and a magnification of 400. As shown, there is a clear boundary between the primer coat and the while topcoat, indicating that no mixing occurs between the two coats. Above results indicates that the primer coat formed from an aqueous dispersion of a vinylidene chloride/acrylic acid/vinyl chloride terpolymer has a good sealing effect on tannin or rosin.

Although the present invention has been described with reference to numerous embodiments and examples, those of ordinary skill in the art will recognize from the present invention that other embodiments can be devised without departing from the scope and spirit of the invention.

1. An article comprising
(a) a wood substrate, comprising at least one of tannin and rosin;
(b) a primer coat directly applied on a major surface of the wood substrate, formed from a water borne clear paint comprising an aqueous dispersion of vinylidene chloride-acrylic acid-vinyl chloride terpolymer; and
(c) at least one light-colored topcoat applied on the primer coating.

2. The article as claimed in claim 1, wherein the primer coat has a thickness in the range of 10-40 micrometers.

3. The article as claimed in claim 1, wherein the aqueous dispersion is neutralized with a base.

4. The article as claimed in claim 1, wherein the aqueous dispersion has a pH in the range of 3-6.

5. The article as claimed in claim 3, wherein the base comprises an alkali metal salt, an alkali earth metal salt, an amine, ammonia or the combination thereof.

6. The article as claimed in claim 1, wherein the aqueous dispersion has a viscosity ranging from 20 mPa·s to 100 mPa·s at 25° C.

7. The article as claimed in claim 1, wherein the water borne clear paint comprises, relative to the total weight of the water borne clear paint,
60-90 wt % of the aqueous dispersion of vinylidene chloride-acrylic acid-vinyl chloride terpolymer,
5-20 wt % of water; and
0-35 wt % of additional additives, comprising one or more selected from a co-solvent, a coalescing agent, a wetting agent, a defoamer, a surfactant, an anti-sagging agent, and a thickener.

8. The article as claimed in claim 7, wherein the water borne clear paint comprises, relative to the total weight of the water borne clear paint,
70-90 wt % of the aqueous dispersion of vinylidene chloride-acrylic acid-vinyl chloride terpolymer,
9-20 wt % of water; and
0.1-10 wt % of additional additives, comprising one or more selected from a co-solvent, a coalescing agent, a wetting agent, a defoamer, a surfactant, an anti-sagging agent, and a thickener.

9. The article as claimed in claim 1, wherein the wood substrate has a tannin or rosin content of at least 0.1 wt %.

10. The article as claimed in claim 1, wherein the wood substrate has a tannin or rosin content of at least 1 wt %.

11. The article as claimed in claim 1, wherein the wood substrate has a tannin or rosin content of at least 10 wt %.

12. The article as claimed in claim 1, wherein the wood substrate comprises a soft wood substrate, a hard wood substrate, engineered wood composites or any combination thereof.

13. The article as claimed in claim 12, wherein the soft wood substrate comprises pine, cedar or fir.

14. The article as claimed in claim 12, wherein the hard wood substrate comprises ashtree, white ash, basswood, elm, maple, birch, alder, beech, oak, rubber wood, cherry, walnut, or rosewood.

15. The article as claimed in claim 12, wherein the engineered wood composites comprises plywood, oriented strand board (OSB), medium-density fiberboard (MDF), particle boards or a combination thereof.

16. The article as claimed in claim 1, wherein the topcoat is white-colored.

17. The article as claimed in claim 1, wherein the topcoat is formed from a water borne coating composition or a solvent borne coating composition.

18. The article as claimed in claim 1, wherein the topcoat has a color difference Δ E of no greater than 3 as measured with ASTM D2244 before and after being heated at 50° C. for 3 days.

19. Use of an aqueous dispersion of vinylidene chloride-acrylic acid-vinyl chloride terpolymer for preventing tannin and/or rosin from immigrating out from a wood substrate.

20. The use as claimed in claim 19, wherein the aqueous dispersion is neutralized with a base.

21. The use as claimed in claim 19, wherein the aqueous dispersion has a pH in the range of 3-6.

22. The use as claimed in claim 19, wherein the wood substrate has a tannin or rosin content of at least 0.1 wt %.

23. The use as claimed in claim 19, wherein the wood substrate has a tannin or rosin content of at least 1 wt %.

24. The use as claimed in claim 19, wherein the wood substrate has a tannin or rosin content of at least 10 wt %.
